(19) United States
(12) Patent Application Publication
(10) Pub. No.: US 2007/0005449 A1
(43) Pub. Date: Jan. 4, 2007

(54) Optimized retail application user interface and architecture

(75) Inventors: Ashvin J. Mathew, Kirkland, WA (US); Jeff Blucher, Seattle, WA (US); Gregg Dingle, Mill Creek, WA (US); Tim Cooper, Redmond, WA (US); Derrick S. Bazlen, Woodinville, WA (US); Matthew Cibelli, Seattle, WA (US); Brendan O'Meara, Bellevue, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/169,745

(22) Filed: Jun. 30, 2005

(51) Int. Cl. G07F 7/00; G06F 17/30; G06Q 30/00

(52) U.S. Cl. 705/27; 705/1; 705/26

(57) ABSTRACT

A user interface for transaction applications is disclosed. The interface may include a focus area in which commonly-used functions are represented by interface elements, as determined by the frequency with which users select the function, or by user preference. The interface may also include an expanded entry for a selected item.

### BACKGROUND

The power of the computer has brought new capabilities to nearly every facet of today's business world. In the case of retail transactions, computers now assist with inventory tracking and management, pricing, accounting, credit tracking, and a host of other tasks that were formerly done by hand. These added capabilities, however, also bring a new set of problems. One such problem arises from the sheer volume of available computerized commands. With a computerized retail transaction terminal, commands and options are all-too-often poorly arranged and organized. The retail clerk needs to spend a considerable amount of time simply learning the availability of commands and features, and how to access them.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One or more aspects described herein can provide an optimized retail interface for handling transactions, such as point of sale transactions. In some aspects, a touch-sensitive display is used to present an interface to the user. The display may include a focus area of the screen, in which contextually-related interface objects may be sequentially displayed as the user processes a transaction.

In some aspects, the interface may include a listing of items, such as items that are available for purchase. The listing may include an expanded item entry offering additional options for one of the listed items, where the expanded entry is placed within the list itself.

In some aspects, the interface may include one or more multi-mode menu buttons, where pressing one portion of the button brings up a menu of options, and pressing a sub-portion of the button performs a predetermined selection of one of the options, without requiring display of and selection from the button's menu.

In some aspects, a portion of the display may be customized to present easy access to the most commonly used functions. This customization may be user-determined, and may be based on the frequency with which the user accesses particular functions.

These and other aspects will be described herein.

### BRIEF DESCRIPTION OF THE DRAWINGS

Features of the system are described in detail below with reference to the attached drawing figures, wherein:

FIG. 1 is a block diagram of a computing-system environment suitable for use in implementing one or more features described herein.

FIG. 2 is a display screen usable for a retail transaction.

FIGS. 3-7 are a sequence of display screens that may be used for a retail transaction.

FIG. 8 is a display screen usable for a retail transaction, in which a menu of options is displayed.

FIG. 9 depicts examples of two graphical interface buttons.

FIG. 10 is a portion of a display screen having a menu of options displayed.

FIG. 11 is a display screen usable for a retail transaction.

FIGS. 12 and 13 depict examples of interface displays that may appear in a focus area of display screens used for retail transactions.

### DETAILED DESCRIPTION

The system described herein relates to a system and method for providing an improved user interface for processing a retail transaction. An example operating environment is described below.

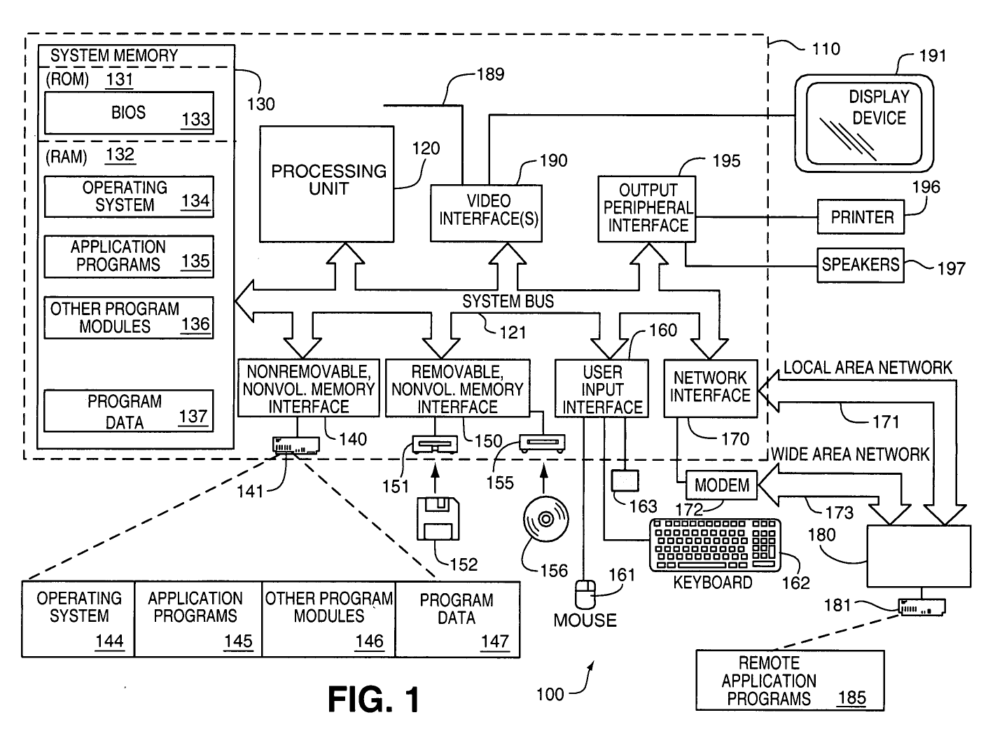

Referring to the drawings in general and initially to FIG. 1 in particular, wherein like reference numerals identify like components in the various figures, an exemplary operating environment is shown and designated generally as operating environment 100. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

The features described herein may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the features may be practiced with a variety of computer-system configurations, including hand-held devices, multiprocessor systems, microprocessor-based or programmable-consumer electronics, minicomputers, mainframe computers, and the like. They may also be practiced in distributed-computing environments where tasks are performed by remote-processing devices that are linked through a communications network. In a distributed-computing environment, program modules may be located in both local and remote computer-storage media including memory storage devices.

With reference to FIG. 1, an exemplary system 100 includes a general purpose computing device in the form of a computer 110 including a processing unit 120, a system memory 130, and a system bus 121 that couples various system components including the system memory 130 to the processing unit 120. If desired, any of the elements described herein may be implemented as standalone elements (e.g., a single processing unit), or as multiple elements working in concert (e.g., multiple processing units).

Computer 110 typically includes a variety of computer-readable media. By way of example, and not limitation, computer-readable media may comprise computer-storage media and communication media. Examples of computer-storage media include, but are not limited to, Random Access Memory (RAM); Read-Only Memory (ROM); Electronically Erasable Programmable Read-Only Memory (EEPROM); flash memory or other memory technology; CD-ROM, digital versatile discs (DVD) or other optical or holographic disc storage; magnetic cassettes, magnetic tape, magnetic disk storage or other magnetic storage devices; or any other medium that can be used to store desired information and be accessed by computer 110. The system memory 130 includes computer-storage media in the form of volatile and/or nonvolatile memory such as ROM 131 and RAM 132. A Basic Input/Output System 133 (BIOS), containing the basic routines that help to transfer information between elements within computer 110 (such as during start-up) is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer-storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD-ROM or other optical media. Other removable/nonremovable, volatile/nonvolatile computer-storage media that can be used in the exemplary operating environment include, but are not limited to, magnetic tape cassettes, flash memory units, digital versatile disks, digital video tape, solid state RAM, solid state ROM, and the like. The hard disk drive 141 is typically connected to the system bus 121 through a nonremovable memory interface such as interface 140. Magnetic disk drive 151 and optical disc drive 155 are typically connected to the system bus 121 by a removable memory interface, such as interface 150.

The drives and their associated computer-storage media discussed above and illustrated in FIG. 1 provide storage of computer-readable instructions, data structures, program modules and other data for computer 110. For example, hard disk drive 141 is illustrated as storing operating system 144, application programs 145, other program modules 146, and program data 147. Note that these components can either be the same as or different from operating system 134, application programs 135, other program modules 136, and program data 137. Typically, the operating system, application programs and the like that are stored in RAM are portions of the corresponding systems, programs, or data read from hard disk drive 141, the portions varying in size and scope depending on the functions desired. Operating system 144, application programs 145, other program modules 146, and program data 147 are given different numbers here to illustrate that, at a minimum, they can be different copies. A user may enter commands and information into the computer 110 through input devices such as a keyboard 162; pointing device 161, commonly referred to as a mouse, trackball or touch pad; a wireless-input-reception component 163; or a wireless source such as a remote control. Other input devices (not shown) may include a microphone, joystick, game pad, satellite dish, scanner, or the like. These and other input devices are often connected to the processing unit 120 through a user-input interface 160 that is coupled to the system bus 121 but may be connected by other interface and bus structures, such as a parallel port, game port, IEEE 1394 port, or a universal serial bus (USB), or infrared (IR) bus.

A display device 191 is also connected to the system bus 121 via an interface, such as a video interface 190. Display device 191 can be any device to display the output of computer 110 not limited to a monitor, an LCD screen, a Thin Film Transistor (TFT) screen, a flat-panel display, a conventional television, or screen projector. In addition to the display device 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local-area network (LAN) 171 and a wide-area network (WAN) 173 but may also include other networks, such as connections to a metropolitan-area network (MAN), intranet, or the Internet.

When used in a LAN networking environment, the computer 110 may be connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the network interface 170, or other appropriate mechanism. Modem 172 could be a cable modem, DSL modem, or other broadband device. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Other internal components of the computer 110 are possible, but not shown. For example, various expansion cards such as television-tuner cards and network-interface cards may be incorporated within a computer 110.

When the computer 110 is turned on or reset, the BIOS 133, which is stored in ROM 131, instructs the processing unit 120 to load the operating system, or necessary portion thereof, from the hard disk drive 141 into the RAM 132. Once the copied portion of the operating system, designated as operating system 144, is loaded into RAM 132, the processing unit 120 executes the operating-system code and causes the visual elements associated with the user interface of the operating system 134 to be displayed on the display device 191. Typically, when an application program 145 is opened by a user, the program code and relevant data are read from the hard disk drive 141 and the necessary portions are copied into RAM 132, the copied portion represented herein by reference numeral 135.

The hardware described above and features described herein may be used in a variety of situations, such as a terminal used to process a retail transaction. For example, the computer 110 may serve as a cash register at a department store checkout, and the various displays may appear on a display device 191 that is sensitive to a user's hand or finger, or to a user input device, such as a pen or stylus.

As previously mentioned, the features described herein may be described in the general context of computer-useable instructions. Computer-useable instructions include functions, procedures, schemas, routines, code segments, and modules useable by one or more computers or other devices. The computer-useable instructions form an interface to allow a computer to react according to a source of input. The instructions cooperate with other code segments to initiate a variety of tasks in response to data received in conjunction with the source of the received data.

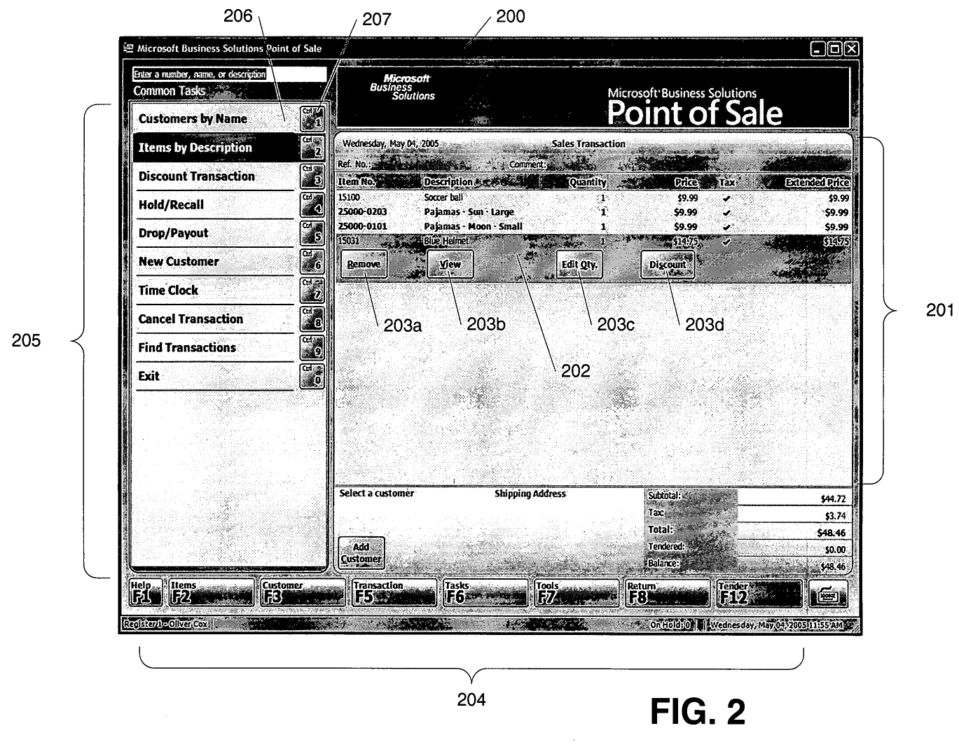

The system shown in FIG. 1 may be used to implement a point of sale, such as a computerized cash register, and FIG. 2 illustrates an example user interface display that can be used to process a retail transaction at such a point of sale. In the screen 200, there may be a transaction area 201 listing the principal information for a retail transaction. For example, screen 200 may be used at a department store checkout, and area 201 may list the individual items that a purchaser has selected for purchase. Transaction area 201 may include, within the listing, an expanded listing entry 202 for one of the listed items. Expanded entry 202 may include one or more additional graphic user interface elements 203a-d, such as graphical buttons for removing an item 203a, viewing more details on an item 203b, editing the quantity of the item for purchase 203c, and/or entering a discount for the listed item 203d. The expanded entry may automatically appear for one of the items, such as the first item, last item, most recently added item, etc. Alternatively, the user may select a particular entry for expansion by touching, tapping, or navigating a cursor to the desired entry. So, for example, the user may touch a different listed item (e.g., the “Pajamas-Moon-Small” item, and that entry would be expanded to appear as expanded entry 202, while the previously-expanded entry may return to a normal, smaller size). The expanded entry 202 may be limited to just one of the listed items, and in doing so screen space may be conserved, and the likelihood of a user inadvertently editing the wrong entry is reduced.

Screen 200 may include a plurality of graphic user interface buttons 204 that can be used to perform computer functions and/or display a sub-menu of available computer functions. The buttons 204 may delineate a region of the screen with borders, and may have a common appearance (e.g., common color, shading, etc.). These buttons 204 may correspond to function keys appearing on a keyboard, such as keyboard 162, situated at the terminal.

Screen 200 may also include a focus area 205, such as a task pad. Focus area 205 may be a consistent area of the display in which commonly-used commands are made available as shortcuts. The focus area 205 contents may be a plurality of user interface elements 206 that correspond to the commonly-used commands. These elements 206 may appear listed, and may include graphical buttons 207 that correspond to keys on another input device, such as a keyboard 162. By touching, tapping, or navigating a cursor to a desired element 206, or by pressing the corresponding key on an input device (e.g., keyboard 162), the user may cause the computer to perform an associated function. Other forms of interaction with the element 206 may also be used to cause its selection.

As noted above, the focus area 205 may be used to consistently present users with their most-commonly used functions and/or commands. The specific contents of the focus area 205 may be determined by the user. For example, the screen 200 may offer a command to add a particular function to the focus area 205. If the particular function appears elsewhere on the screen 200, such as on a button 204, the user can add that button's function to the focus area 205 by touching the button, dragging it onto the focus area 205, and then releasing the user's finger. Conversely, to remove a particular element from the focus area 205, the user may touch the element and drag it to a location outside of the focus area 205. Other forms of adding and/or removing elements 206 may also be used. For example, a separate dialog or menu may be used to add functions and/or buttons.

As an alternative, one or more of the elements 206 may be automatically added to the focus area 205. For example, the terminal may maintain historical statistics regarding the various functions selected by the user, such as their total frequency of use, frequency of use by time of day (or day of week or date), frequency of use by type of products selected for purchase etc. to predict which functions are most likely to be used, and which functions should appear in the focus area 205. So, for example, a predetermined number of elements 206 may correspond to the most frequently used functions. The assignment of task pad element 206 need not be entirely based on historical data—the system may, for example, automatically adjust the elements 206 based on predictions using forecasting information. For example, if a particular type of product is on sale this week, or if a particular promotional discount is scheduled to be run, the terminal's software may automatically add an element 206 for the upcoming sale item or promotional discount. Similarly, if a promotion or sale expires, the terminal software may automatically remove a corresponding element 206 from the focus area 205. Any other type of forecasting may be used (e.g., using changes in season, changes in customer preference, marketplace changes, etc.).

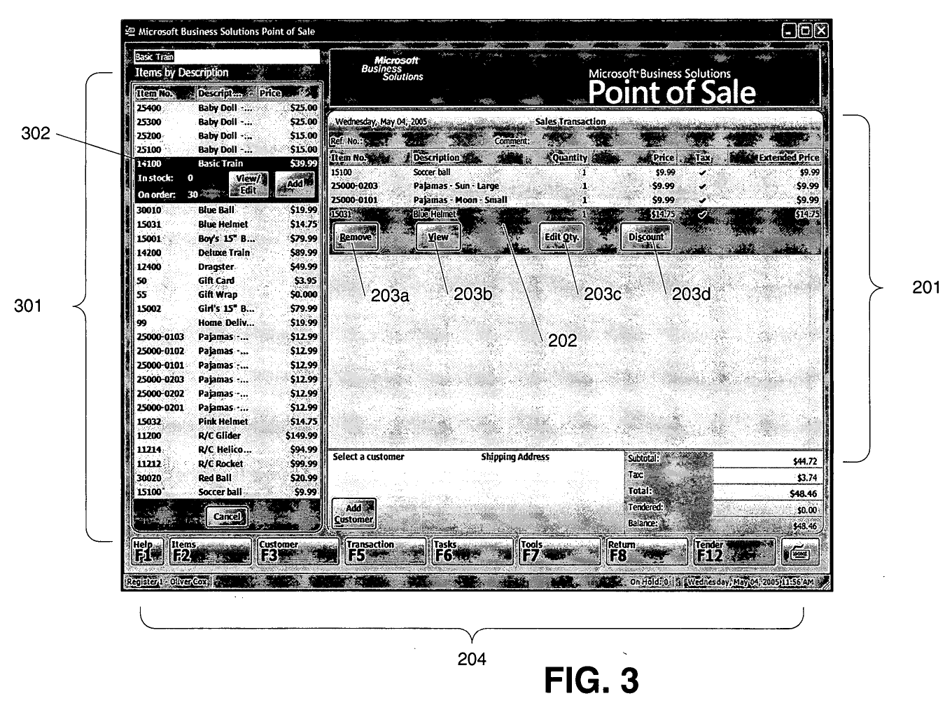

The focus area 205 may be used as a consistent area in which functions are handled. For example, by selecting an “Items by Description” function in screen 200, the focus area 205 may replace the previously-displayed elements 206 with information corresponding to the requested function. In FIG. 3, the focus area 205 now displays the desired information—in this example, the listing 301 of items by their descriptions is shown. In some aspects, such screen changes may be restricted to the focus area 205, such that the user “drills down” in a consistent area of the screen. Keeping the focus area 205 the constant area of focus can be advantageous, in that the user can always know where to look, and so that other areas, such as the transaction information in area 201 always remains visible. Such ease of use may be particularly helpful to, for example, restaurant wait staff balancing a tray of food on one hand, or amputees.

The listing 301 may include an internal expanded entry 302, in which additional information and/or selectable user interface elements (e.g., buttons) corresponding to the expanded listing in the same manner as the expanded entry 202 in screen 200. The contents of an expanded entry 302 may be automatically selected so as to be contextually-appropriate in view of other elements displayed on screen 200. For example, if the selected entry does not already appear in transaction area 201, the expanded entry 302 may include graphical buttons for adding the item to the items in the transaction area 201. If the entry 302 corresponds to an item that is already in the transaction area 201 (e.g., already selected for purchase), the user may use the same graphical buttons to add additional items of the same type to the purchase. Alternatively, if the expanded entry 302 corresponds to an item that is already in the transaction area 201 (e.g., already selected for purchase), the expanded entry 302 might include an additional button for removing the item from the transaction area 201. As with expanded entry 202, the focus area 205 may also limit the number of expanded entries to a single selected entry to minimize the chance for confusion. The user may, for example, touch, tap, or navigate a cursor to the desired listing to expand its entry, thereby causing the previously expanded entry to shrink back to the size of the other listings in the focus area 205. Additionally, the buttons herein may contain keyboard shortcuts to allow their selection through key commands on a keyboard (e.g., one button may use a Ctrl-Enter combination, while another might correspond to an Enter key). Other keyboard shortcut types may also be used. Buttons in other areas may have other contextually-appropriate key mappings to serve as access keys. For example, an Alt-R key combination may be associated with a button in a transaction display to remove an item from a transaction.

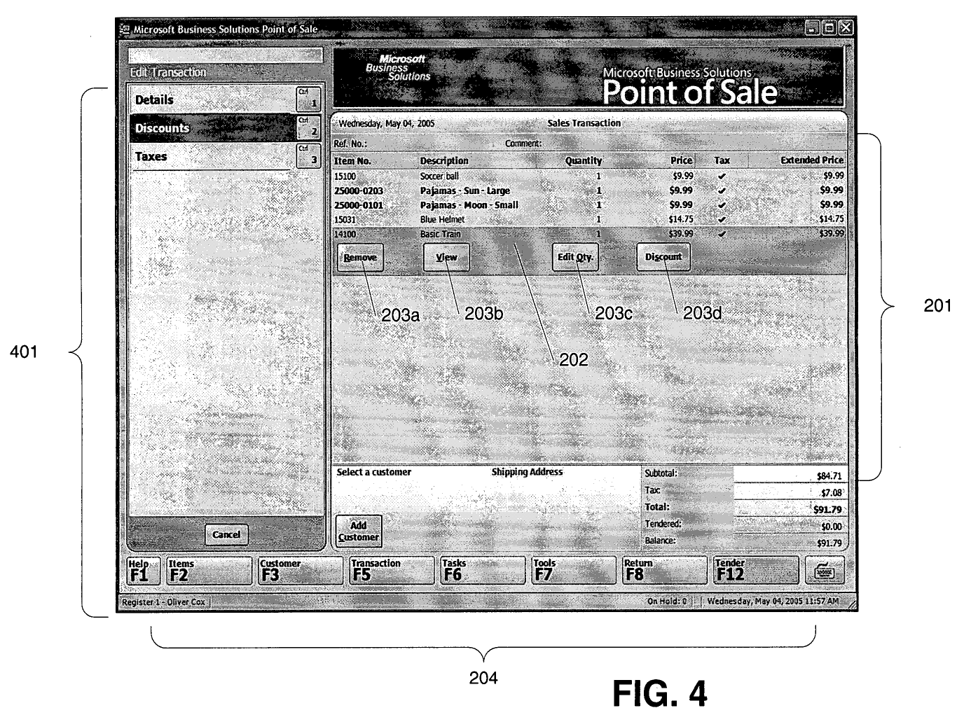

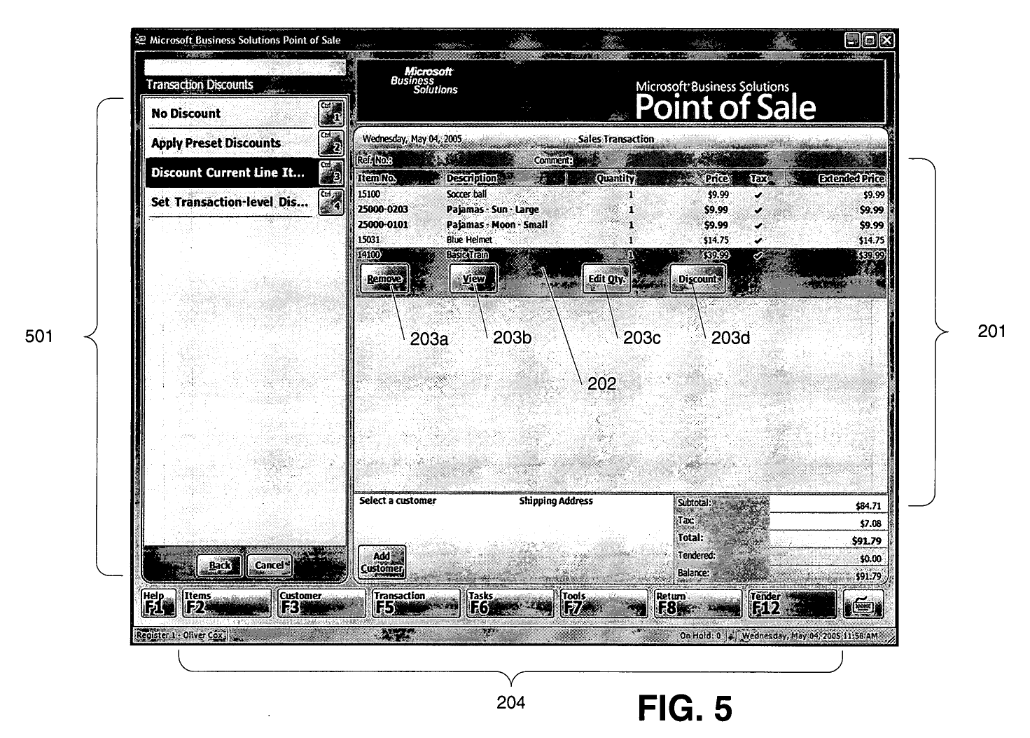

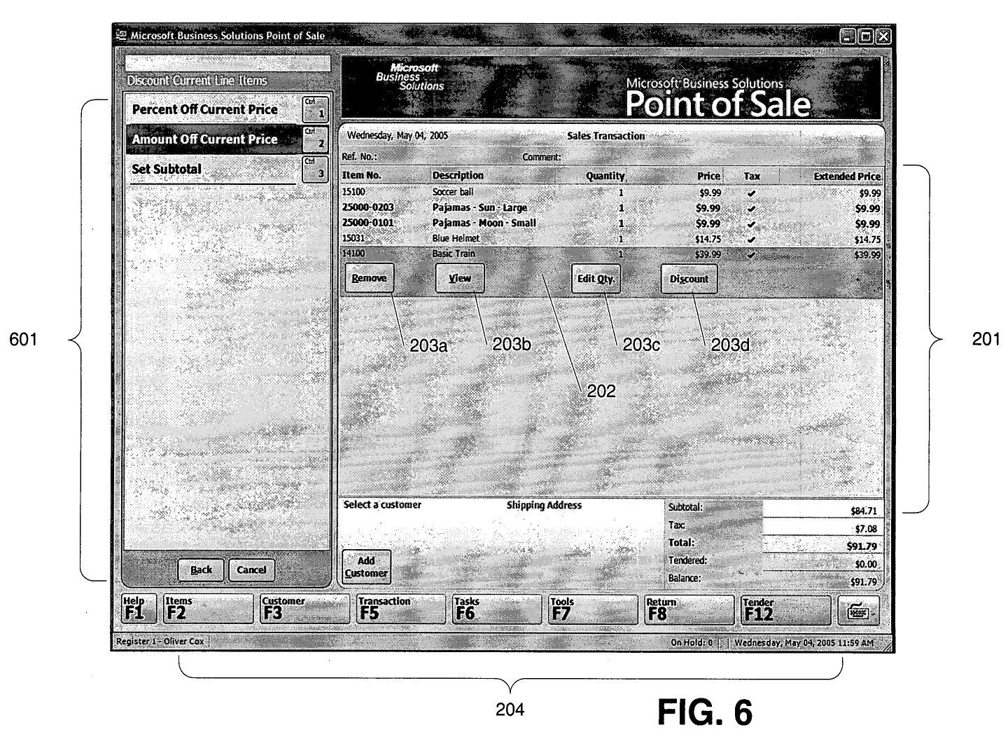

In general, the system may confine screen changes to focus area 205 to minimize the area of the screen with which the user must interact, and keeping other areas constant in appearance, thereby reducing the likelihood of confusion or error. For example, the item listing 301 replaced the previous task pad in focus area 205, and future new displays may also be focused on the focus area 205. FIG. 4 shows another example of such a focus. To arrive at the FIG. 4 display, the user may have selected a “View/Edit” option from expanded entry 302. In response to the selection, the system may once again replace the interfaces shown in focus are 205, this time displaying the interface elements 401 that are contextually-appropriate given the previous selection (e.g., options for editing a transaction using the expanded listing 302). In the FIG. 4 example, the user may be given the option of viewing the transaction details, the applicable discounts, or the taxes to be paid for the selected item. FIG. 5 shows a screen appearing in response to selecting the “Discounts” interface element (e.g., button) from listing 401. The focus area 205 now shows a listing 501 of interface elements and information that corresponds to applicable discounts for the selected item (e.g., if the item is on sale this week). Similarly, FIG. 6 shows a sequential screen that may appear in response to a user selecting a discount option from listing 501, in which a number of further discounting options 601 are shown.

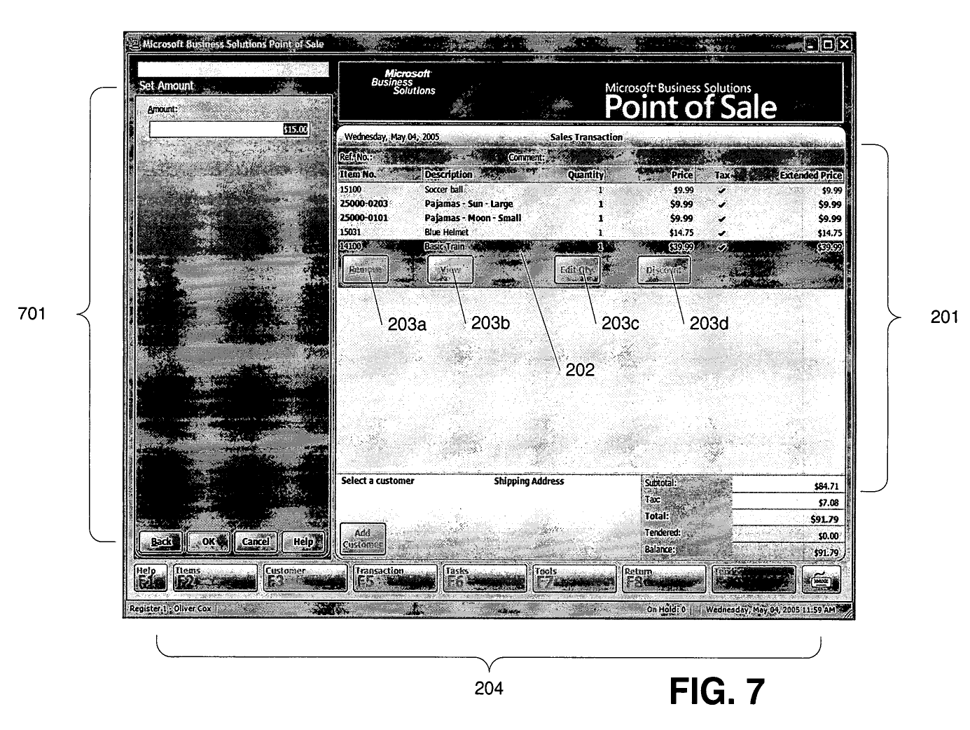

FIG. 7 continues the sequence with another screen, in which a new display 701 is shown in focus area 205 as replacing the prior display, and having further information and interface elements that are contextually appropriate with the user's prior selections (e.g., in this example, offering the user the option to enter the actual discount amount). Note that if desired, interface elements that are contextually inappropriate (e.g., the buttons 203a-d are not used in the process of setting a discount amount) may be altered in appearance (e.g., shaded grey) and/or may be rendered inactive. In some instances, such interface elements may be removed altogether from the display. By removing contextually inappropriate interface elements, the system may force the user to complete the task at hand (e.g., entering a discount amount) before moving on to a different task, thereby helping to avoid confusion.

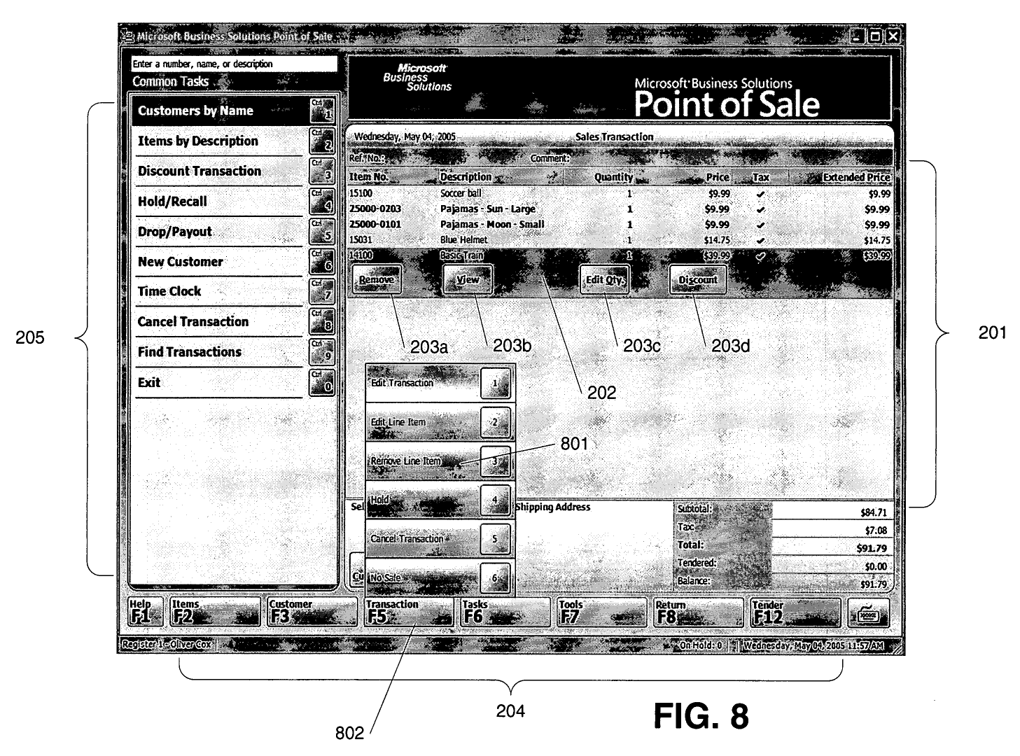

FIG. 8 shows an example screen in which a sub-menu 801 of options is displayed. Such menus may correspond to interface elements appearing on screen. In the example, menu 801 contains a number of options that correspond to the “Transaction” button 802, and these options may appear in menu form when the user selects that “Transaction” button 802. The user may peruse the displayed sub-menu options, and select one in the same in which other interface elements may be selected (e.g., by pressing a corresponding key on a keyboard 162, touching the entry in the menu 801, moving a cursor to the entry in the menu 801, or otherwise selecting a menu option).

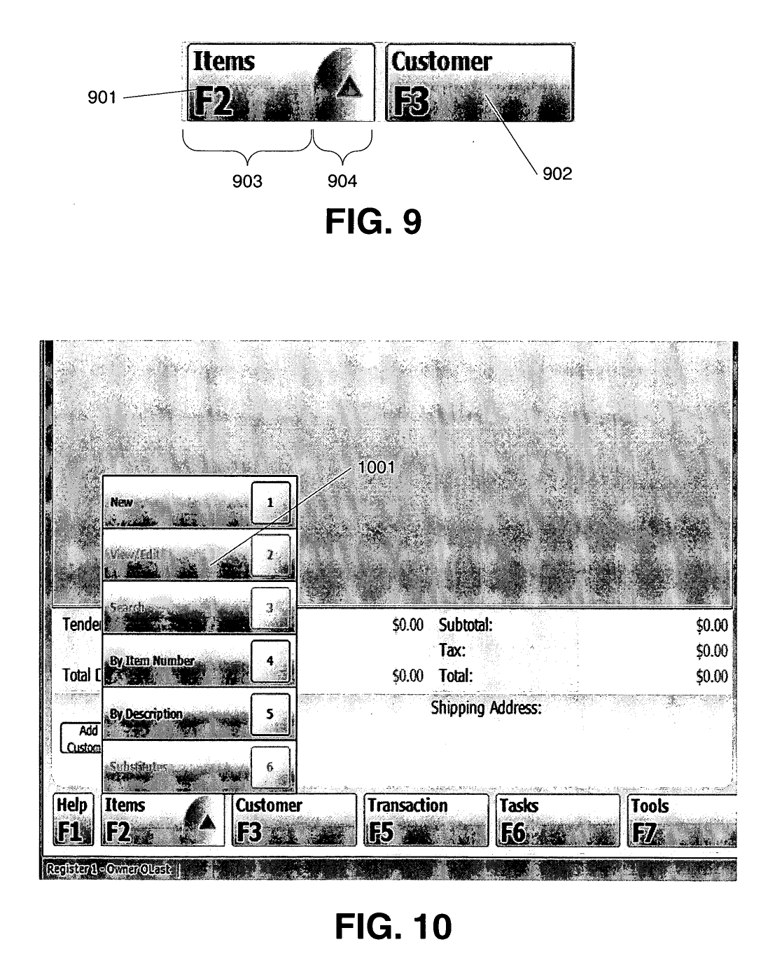

FIG. 9 illustrates two example button interface elements 901, 902 that may be used in the screens described herein. Button 901 may be a multi-mode button (indeed, any of the buttons shown in the figures can be implemented as a multi-mode button). A multi-mode button 901 may correspond to a sub-menu of options, such as menu 801, and may have multiple modes of operation based on the portion of the button that is selected by the user. For example, the button may be associated with both a sub-menu of options, and a default one of the sub-menu of options. The default may be one of the options in the sub-menu, and may be selected based on frequency of use (e.g., the most frequently used menu option), the timing of use (e.g., the most recently used menu option), the likelihood of use (e.g., the option most likely to be used based on factors such as promotions, sale prices, current context, etc.), by user selection (e.g., the user can assign a particular option to be the default), or any other desired method of identifying a default option from a list of available options. The button may be subdivided into multiple portions, and by pressing the first portion 903 of the multi-mode button 901, the user can automatically cause the selection of the button's default command, without having to view the sub-menu. By pressing the second portion 904 of the button 901, the user may view the sub-menu and make an appropriate selection. FIG. 10 shows an example portion of a screen in which a menu 1001 appears in response to the user selecting the second portion 904 of the button 901. Having these two portions of the same button may help efficiency, in that less display space is needed (as compared to having two separate buttons, due to the periphery space consumed by each button).

In some aspects, both portions of the multi-mode button can share display characteristics (e.g., both within the same overall button border, both have same colors, etc.). However, the first portion 903 may be configured to be larger in size, more brightly colored, and/or otherwise made more prominent that the second portion 904 to differentiate the two portions and make individual selection easier. Indicia may also be used to identify the two portions. For example, an arrow or triangle, as shown in FIGS. 9 and 10, may be used to indicate that a menu may be displayed upon selection. Some portions, such as the second portion 904, may include different shading, and may have a curved appearance to resemble that of a user's finger or fingerprint.

The multi-mode operation may also extend to the corresponding keyboard keys. For example, the “Items” button shown in FIG. 10 is shown as being associated with the F2 key. Pressing the F2 key on an associated keyboard may cause the same behavior as selecting one of the two button portions. For example, pressing F2 on the keyboard may cause the default option in the “Items” menu to be selected. A separate related button press, such as a SHIFT-F2, CTRL-F2, ALT-F2, etc. may be interpreted as a selection of the other portion of the multi-mode button.

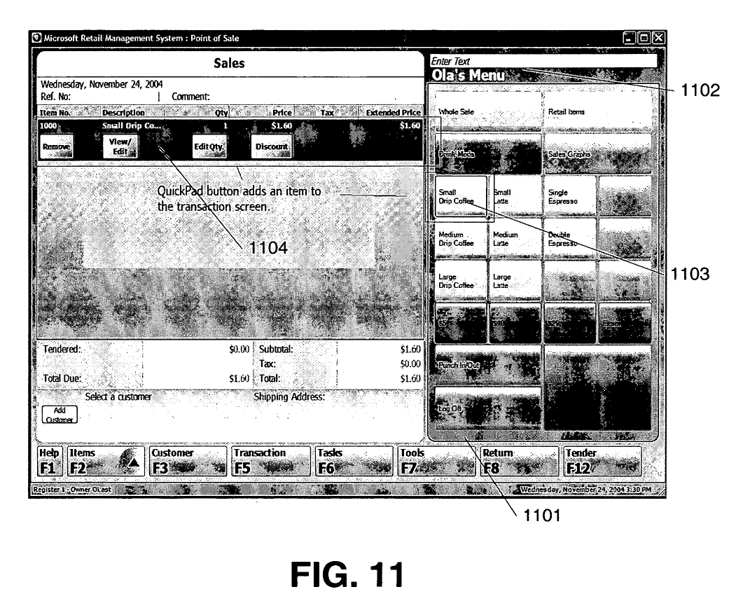

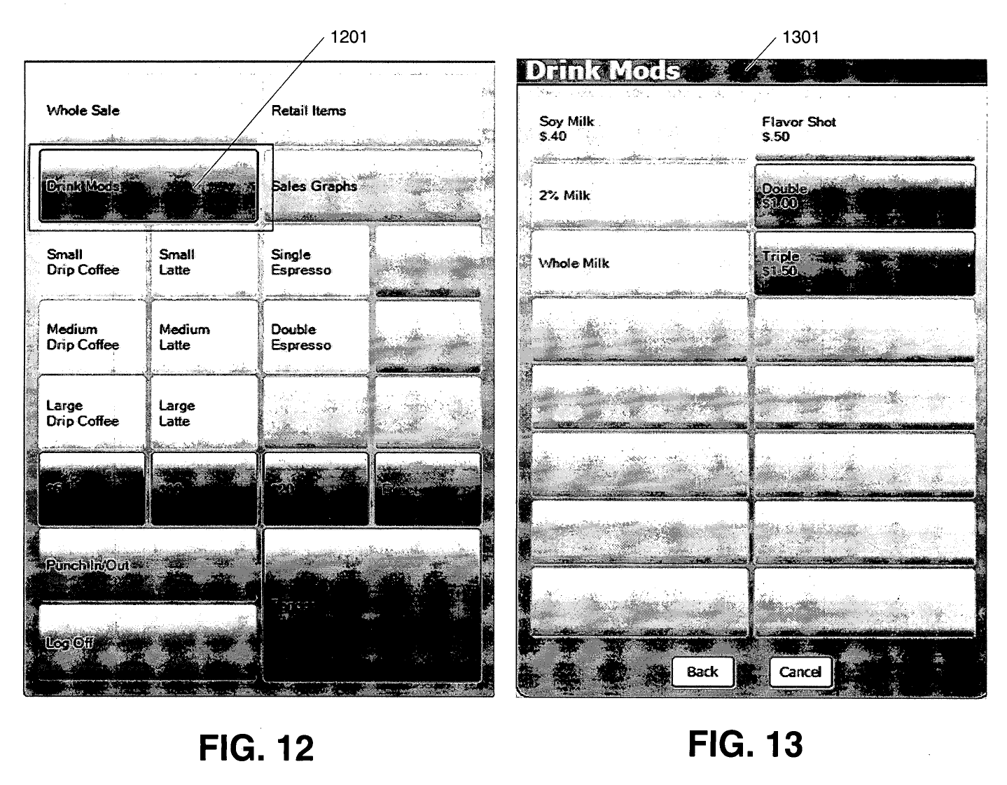

FIGS. 11-13 depict example screens that may be used in focus area 1101, which in FIG. 11 has been located at the right side of the screen (the location of the focus area can be defined by user preference). The area 1101 may include a plurality of interface elements 1102 corresponding to commonly-used functions. For example, selecting a “Small Drip Coffee” button 1103 can add that item to the transaction area 1104 for purchase. Selecting another button, such as the “Drink Mods” button 1201 shown in FIG. 12, may cause another display to appear, offering a further, contextually-related, set of interface elements. For example, FIG. 13 shows a separate display 1301 that can appear in the focus area 1101.

Other features may also be employed. For example, the user may be given an option (such as a menu option, dialog box, etc.) allowing the user to change the font size, font family, style, position, etc. of the various elements, buttons and text appearing on the displays. The user may also be given the option of assigning a custom, or a predefined, image to a button to assist in ease of understanding, and may also be given control over size and positioning of the image on the button.

Additionally, in the above, references to certain features being found in one or more “aspects” or “embodiments” of “the present invention” are made simply to illustrate various concepts that may be advantageously used alone or in combination with other concepts, and should not be read to imply that there is only one inventive concept disclosed herein, or that all of the described features are required in any of the claims that follow. Rather, each of the following claims stands as its own distinct invention, and should not be read as having any limitations beyond those recited.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer display device having a user interface rendered thereon, the interface including the following elements:
a transaction area having a plurality of entries corresponding to a plurality of items selected for purchase, wherein one of said entries is an expanded entry having one or more user interface elements not displayed with others of said entries; and
a focus area including a plurality of user interface elements, wherein said elements are selected for inclusion in said focus area based on a frequency with which a user selects functions corresponding to said elements.

2. The display device of claim 1, wherein said plurality of entries are selectable, and said expanded entry is expanded in response to a user selection of one of said entries.

3. The display device of claim 2, wherein said display device is touch sensitive, and said selection is accomplished by a user touching an area of said display device in which said selected entry is displayed.

4. The display device of claim 1, wherein said plurality of user interface elements in said focus area are automatically included in said focus area based on said frequency.

5. The display device of claim 1, wherein said focus area further includes one or more interface elements selected for inclusion in said focus area by user selection.

6. The display device of claim 5, wherein said user selection is made by dragging a user interface element into said focus area.

7. The display device of claim 1, wherein in response to a selection of one of said user interface elements, the interface elements in said focus area are replaced by a second plurality of interface elements corresponding to said selected element.

8. The display device of claim 1, further comprising one or more multi-mode buttons, wherein selection of a first portion of said multi-mode button results in display of a sub-menu of selectable options; and selection of a second portion of said multi-mode button results in a selection of a default one of the options, without displaying the sub-menu.

9. The display device of claim 8, wherein one of said multi-mode buttons corresponds to a physical key on a keyboard.

10. A method for generating a retail transaction display, comprising the steps of:
displaying a transaction area listing a plurality of items selected for purchase; and
displaying one or more multi-mode user interface buttons, wherein in response to user selection of a first portion of said multi-mode user interface button, a sub-menu of selectable options is displayed; and in response to user selection of a second portion of said multi-mode user interface button, a default one of said options is selected, without displaying said sub-menu.

11. The method of claim 10, further comprising the steps of:
displaying a plurality of selectable user interface elements;
monitoring a frequency with which a user selects said elements; and
adding one or more of said elements to a focus area of said display based on said frequency.

12. The method of claim 10, further comprising the steps of:
displaying a focus area on said display, said focus area including one or more selectable user interface elements; and
selecting functions for inclusion in said focus area based on a predicted frequency of use of said function.

13. The method of claim 10, further comprising the steps of:
displaying a focus area on said display, said focus area including one or more selectable user interface elements; and
adding an interface element to said focus area in response to a user dragging an interface element into said focus area.

14. The method of claim 10, further comprising the steps of:
receiving a user selection of one of said plurality of items; and
expanding a listing of said selected item to include one or more user interface elements not displayed for others of said items.

15. The method of claim 14, wherein only one of said items has an expanded listing in said transaction area.

16. The method of claim 15, further comprising the steps of:
reducing said expanded listing in response to user selection of a different one of said items; and
expanding a listing of said different one of said items.

17. The method of claim 10, further comprising the step of creating an association between one of said multi-mode buttons and a keyboard key.

18. The method of claim 10, wherein said first and second portions of said multi-mode button share a common border.

19. A computer display device having a user interface rendered thereon, the interface including the following elements:
a transaction area having a plurality of entries corresponding to a plurality of items selected for purchase, wherein each of said entries is of a common height, and one of said entries is an expanded entry being taller than the common height, and including one or more user interface elements not displayed with others of said entries; and
a focus area including a plurality of user interface elements, wherein said elements are automatically included in said focus area based on a frequency with which a user selects functions corresponding to said elements.

20. The display device of claim 19, wherein in response to user selection of a different one of said entries, said different entry is expanded, and only one of said entries is expanded at one time.
